(19) United States
(12) Patent Application Publication
(10) Pub. No.: US 2009/0287603 A1
(43) Pub. Date: Nov. 19, 2009

(54) Actionable Alerts in Corporate Mobile Banking

(75) Inventors: Joe N. Lamar, III, Lithia Springs, GA (US); Sean Datcher, Keller, TX (US); Josh Street, Mount Pleasant, NC (US); Melinda M. Stopa Young, Waxhaw, NC (US); L. Miyoshi West, West Orange, NJ (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 12/121,351

(22) Filed: May 15, 2008

(51) Int. Cl. G06Q 40/00; H04L 9/32

(52) U.S. Cl. 705/40; 726/5

(57) ABSTRACT

Techniques for alerting a client about a pending payment over a communication device by a financial institution are disclosed. The client is able to view the alert on a communication device and can reply to the alert with an answer on how to process the pending payment. A designated user can consequently respond to issues without having to call staff or to log into the business's computer system. The response sent through the communication device indicates the designated user's decision to the financial institution's payment system. The payment service determines whether an alerting message should be sent to a designated user based on at least one criterion based on a set of business rules. The designated user is authorized to approve or reject the pending payment. In response to the alerting message, the designated user returns a response that contains payment information and a one-time password.

### FIELD OF THE INVENTION

Aspects of the invention generally relate to mobile banking. More specifically, aspects relate to alerting a client through a communication device that a payment is pending. The client can take action by selecting an option and by replying with a one-time password and option.

### BACKGROUND

A business is often dependent on vendors to provide goods and services vital to the successful operation of the business. Consequently, it is important that the business perform billing and accounting tasks in order to expeditiously resolve payment for goods by paying for or returning unacceptable goods. Business staff may initiate payment for goods or services; however, if the amount of the payment is sufficiently large, business procedures may require a person of sufficient authority to approve the pending payment. Designated personnel having sufficient authority (e.g., purchasing agents, purchasing managers, purchasing directors, corporate treasurer, or corporate cash manager) of the business are often mobile and may spend a significant time traveling. Many times, designated personnel receive a request to approve a wire or other payment type to decide whether to return goods or pay for the goods, or to make a decision on a money transfer while away from the office or personal computer. Typically, alerts from the business's bank merely provide information about what is happening to the business's payments. However, designated personnel can only respond by contacting the office or bank by telephone or by logging into the business's computer system. Designated personnel are often required to continuously poll or access account information, tethering them to the business's computer infrastructure and thus limiting mobility and flexibility in completing financing management tasks.

With the increasing degree of mobility and globalization, it is increasingly important that billing and accounting tasks be performed whether designated personnel are at or away from the office.

### BRIEF SUMMARY

Aspects of the invention address one or more of the issues mentioned above by disclosing methods, computer readable media, and apparatuses for alerting a client about a pending payment over a communication device by a financial institution when triggering criterion occurs. The alert may assume different forms, including short message service (SMS) or multimedia messaging service (MMS). A user is able to view the alert on a communication device and can reply to the alert with an answer on how to process the pending payment. The user can consequently respond to issues without having to call staff or to otherwise log into the business's computer system. The response sent through the communication device indicates the user's decision to the financial institution's payment system.

According to another aspect of the invention, a payment service determines whether an alerting message should be sent to a designated user (client) via a communication device based on a criterion, in which the alerting message is associated with a pending payment. The designated user is authorized to approve or reject the pending payment. In response to the alerting message, the designated user returns a response that contains payment information and a password. If the password is determined to be valid, the payment service initiates actions in accordance with the payment information.

According to another aspect of the invention, if the designated user indicates that the pending payment is approved, the payment is dispensed to the payee through the client's financial institution (e.g., a bank). The pending payment is rejected when the payment information indicates a rejection.

According to another aspect of the invention, the password comprises a one-time password that is generated from a password generator device possessed by the designated user.

According to another aspect of the invention, the payment service generates the alerting message when a trigger condition has occurred based on a set of business rules. The set of business rules may be configured by the client to determine trigger conditions for generating the alerting message.

According to another aspect of the invention, a client profile is configured to include contact information for alerting the designated user. The alerting message is sent to the client based on the contact information.

Aspects of the invention may be provided in a computer-readable medium having computer-executable instructions to perform one or more of the process steps described herein.

These and other aspects of the invention are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a flow diagram of registering a client for actionable alert messaging in accordance with one or more aspects of the invention.

FIG. 4 shows a flow diagram for processing business rules, monitoring pay activities, and generating alert messaging in accordance with an aspect of the invention.

FIG. 5 shows a flow diagram for a client responding to an alerting message and for a financial institution processing the client's response in accordance with an aspect of the invention.

FIG. 6 shows a webpage for a payment service in accordance with an aspect of the invention.

FIG. 7 shows a webpage for a client configuring a payment service in accordance with an aspect of the invention.

FIG. 8 shows a screenshot in which a client initiates a payment in accordance with an aspect of the invention.

FIG. 9 shows an exemplary display on a wireless device in which a client receives an alerting message in accordance with an aspect of the invention.

FIG. 10 shows an exemplary response of a client to an alerting message in accordance with an aspect of the invention.

### DETAILED DESCRIPTION

In accordance with various aspects of the invention, methods, computer-readable media, and apparatuses are disclosed in which a client is alerted about a pending payment. A business (e.g., client of a financial institution) receives bills from a supplier and must pay the supplier in an expeditious manner. Business staff may initiate payment of the bill; however, if the bill is sufficiently large, business procedures may require a person of sufficient authority to approve the pending payment. Often, the responsible person receives a request to approve a wire, decides whether to return the goods or to pay for the goods, or to make a decision on a money transfer while the responsible person is away from the office or personal computer (PC).

According to an aspect of the invention, the responsible person for approving a payment may vary for different purchasing scenarios and is not be limited to purchasing personnel. For example, a purchasing manager may place an order to buy goods or services, where the purchasing manager reports to the corporate treasurer or corporate cash manager. In such a case, the corporate treasurer or corporate cash manager may be required to approve the purchase even though purchasing initiated the payment.

Typical alerts merely provide information about what is happening to the client's payments. However, the client's only way to respond is often to pick-up a phone or log into the PC system. With aspects of the invention, the client can reply to an electronic message (an alerting message which may be referred as an actionable alert) received through a communication device in a secure way with an answer about responding to various payment situations. This capability enables the client to conduct business with a financial institution (e.g., a bank) at any time and from anywhere the client chooses.

Aspects of the invention can apply to an industry that requires process approval. For instance, an insurance agent could modify an existing policy and send an alert to the insured party requesting approval. The insured party could respond using the same protocol and proved approval. As another example, a car repair shop can send an alert to a client with estimated work. The client responds with approval to proceed or decline.

Today, financial transactions are delayed pending approval and release thus causing millions of dollars to be delayed while a client is required to manually check for alerts that require their approval and release. Financial transactions such as wire transfers and automated clearing house (ACH) payments tend to wait unnecessarily for a person to determine that there is action that needs to be taken. Transactions are further delayed if the user is not in a location that would allow the user to access their treasury application over a network. This is causing delays in financial transaction processing in excess of millions of dollars per month in U.S. commerce.

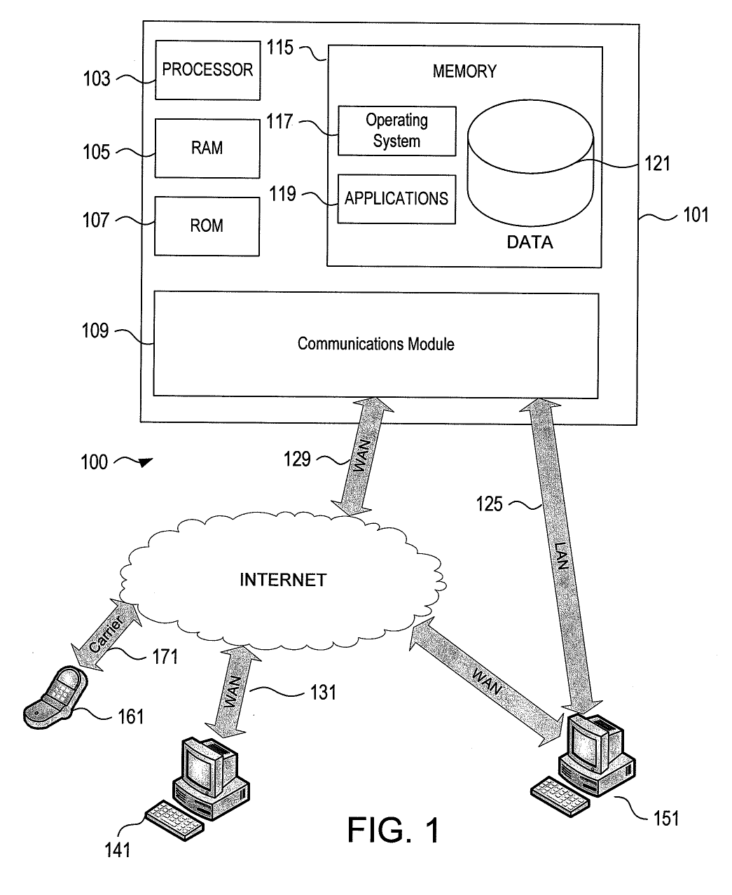

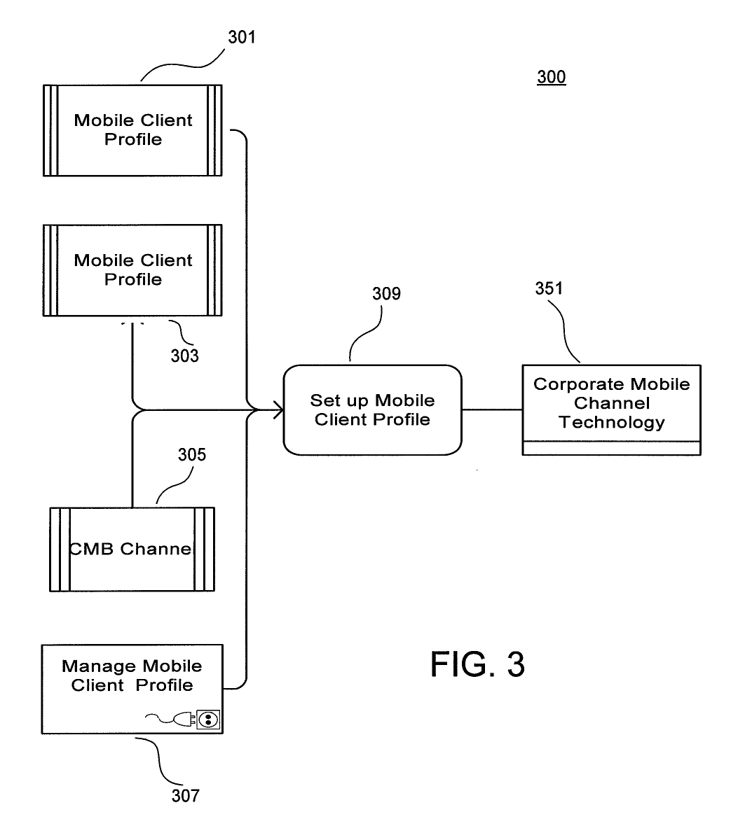

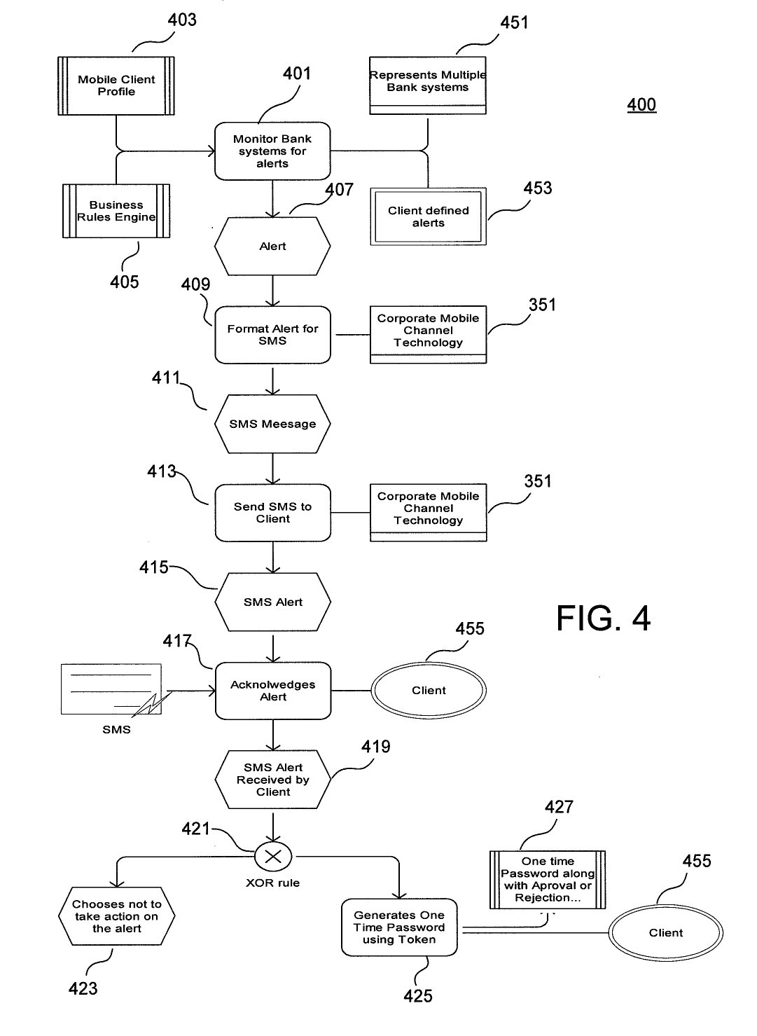

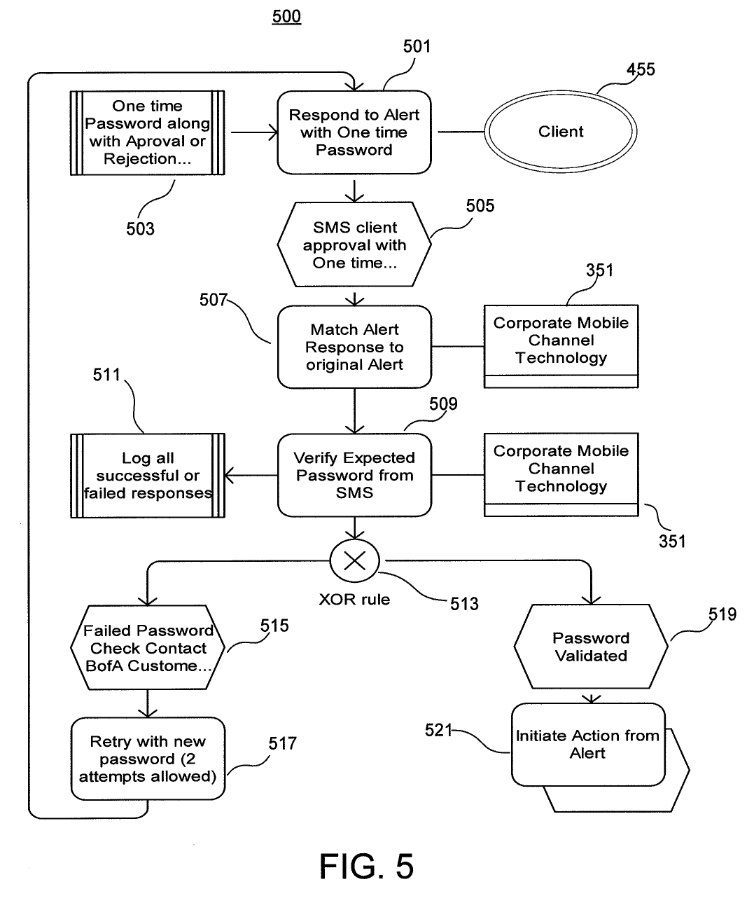

FIG. 1 illustrates an example of a suitable computing system environment 100 (for example, for executing process 300 as shown in FIG. 3, process 400 as shown in FIG. 4, and process 500 as shown in FIG. 5) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of pre-clearance information or trading information for security equities in different jurisdictions.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

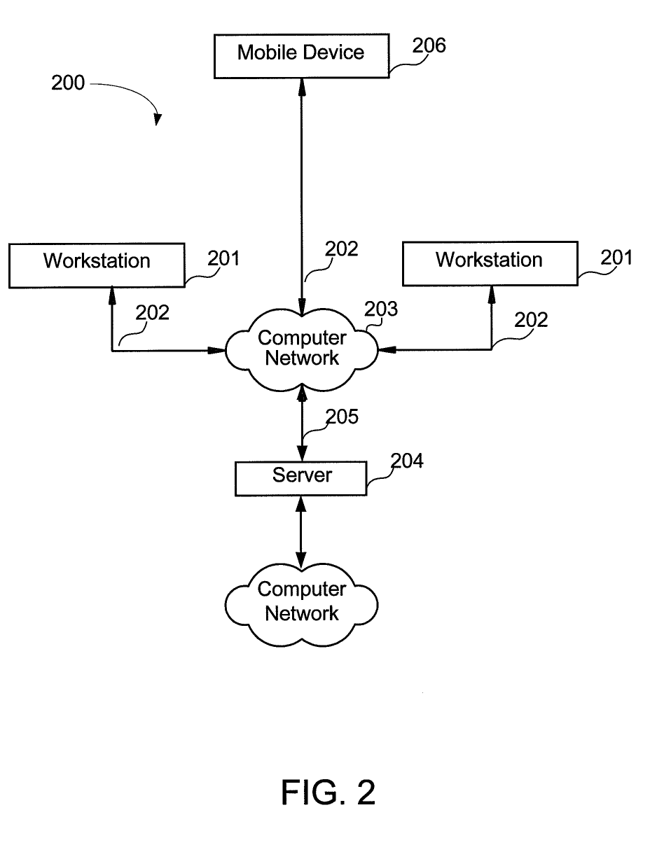

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201, mobile device 206, and server 204, such as network links, dial-up links, wireless links, hard-wired links, etc.

As understood by those skilled in the art, the steps that follow in the Figures may be implemented by one or more of the components in FIGS. 1 and 2 and/or other components, including other computing devices.

FIG. 3 shows flow diagram 300 of registering a client for actionable alert messaging in accordance with an aspect of the invention. In the discussion herein, the term client may refer to a user, member of a business staff, or responsible person who has the authority for deciding on a pending payment. The technology for supporting alerting messaging is referred herein as corporate mobile channel technology 351. A client of a financial institution registers with corporate mobile channel technology 351. Consequently, the client's profile (that may include identification, type of device, device identifier, type of alerts to be notified, format for notification and hours of notification) is stored so that the client can be subsequently alerted.

Actionable alerts enable bank customers to respond to an alerting message that is sent to a communication device based on criteria that was setup by the user or user's company. For example, a payment may be pending in which a business (e.g., hypothetical XYZ-Mart) pays a vendor for goods supplied. Funds will be dispensed by a financial institution (e.g., hypothetical Bank XYZ) when an authorized person approves the payment in response to the alerting message to the person's communication device. The communication device can be one of various types, including a wireless phone, personal computer, personal digital assistant (PDA), cable telephone, and landline telephone. The alerting message can be in the form of short messaging service (SMS), multimedia messaging service (MMS), or e-mail. The financial institution may send an alerting message to the authorized person (user) based on certain decision criteria. The authorized person is able to view the alerting message on the person's communication device. After viewing the alert, the authorized person can reply to the alert with an answer on how to decision each criterion. The authorized person can subsequently respond to issues without having to call staff or to log into a computer system. The response sent through the communication device conveys the authorized person's decision to the payment system of the financial institution.

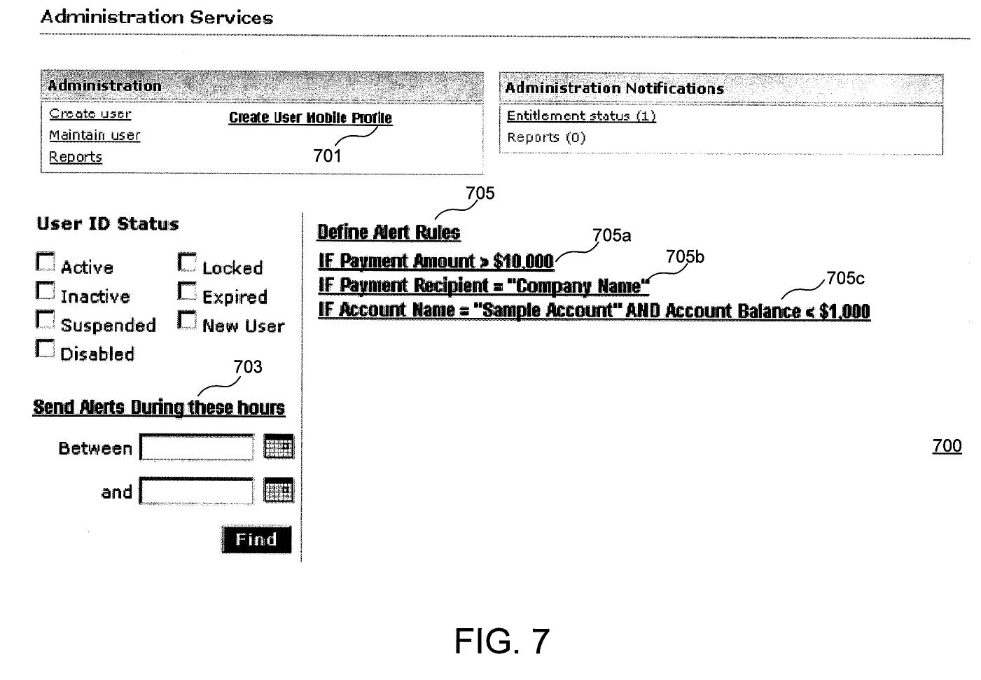

Referring to FIG. 3, mobile client profile 301 or 303 is configured by step 309 by the user through an Internet session over corporate mobile banking (CMB) channel 305. An exemplary screenshot for supporting administrative services, in which business rules and a client profile are configured, is shown in FIG. 7 and is discussed herein. Manage mobile profile 307 represents a technology called web services. The web service interface allows the CMB channel 305 to be accessed from within a bank's internal network by other applications. This allows CMB channel 305 to be leveraged by multiple applications through a single interface.

With an embodiment of the invention, corporate mobile channel technology 351 leverages the SMS message capability and creates a structured message with decision options that a client can utilize to be alerted and take action on a pending financial transaction. The client is able to respond with a one-time password that secures the action that can be triggered by the response. Corporate mobile channel technology 351 reacts to user response and triggers appropriate business processes to complete the requested action from the client. Aspects of the invention provide services to the client based on monitoring, alerting, securing a response, and executing a business action triggered from the response.

All transactions, whether financial or non-financial, that require secure messaging over SMS and that can trigger a business activity may incorporate aspects of the embodiments, including insurance, health, manufacturing and other industries. Any interaction over a predetermined amount triggers an alerting message.

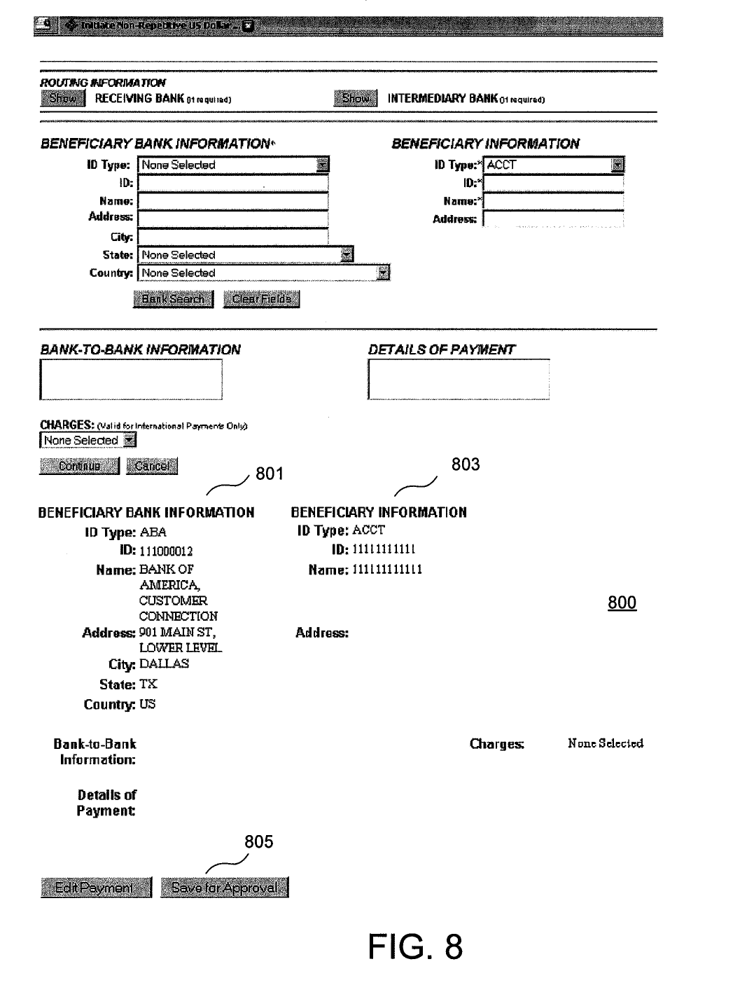

FIG. 4 shows flow diagram 400 for processing business rules, monitoring pay activities, and generating alerting messaging in accordance with an embodiment. In step 401, process 400 monitors banking systems (e.g., a payment system) 451 for alerts based on client defined alerts 453. As an example, banking system 451 may comprise a bank's back-end system for dispensing funds from a client's account to a designated payee. A client may initiate payment to a vendor through beneficiary bank 801 as shown in screenshot in FIG. 8. Client defined alerts 453 are based on mobile client profile 403 and business rules engine 405.

Mobile client profile 403 is configured to provide contact information of the authorized person that can approve a payment. Process 400 may leverage system monitoring based on flexible business rules that trigger alerts. Business rules engine 405 provides information regarding alert rules (e.g., rules 705 as shown in FIG. 7) to specify when alerting message 407 should be generated. Business rules engine 405 is configured according to a client's specification (e.g., define alert rules 705 as shown in FIG. 7) in conjunction with alert configuration information (e.g., send alerts during specified hours 703). Step 401 reads the business rules into memory and evaluates the target banking systems for events that trigger business rules and rules that trigger alerts based on client-defined thresholds. When a business rule is triggered that exceeds client-defined thresholds, process 400 initiates alert 407 through corporate mobile channel technology 351.

Mobile client profile 403 may include one or more designated people based on the amount of a financial transaction, For example, a first user (designated person) is contacted if the amount is between $100,000 and $1,000,000, and a second user is contacted if the amount is more than $1,000,000. In addition to rules based on amounts, the rules can be based on the recipient, originator, account number or any other data item that is used to initiate the payment. For instance, an alert may require three approvals if the payment is initiated by associate x and is designated for recipient y and the amount is greater than $1 MM and the day equals Friday.

When alert 407 is generated, step 409 formats alerting message 411 into the appropriate format as specified by mobile client profile 403. Process 400 formats the alerting message in a client-requested format (e.g., SMS or email) and generates a message identification for reconciliation with the response message. Process 400 renders the message for the transport protocol required for the client and sends the message to the client. For example, in the embodiment shown in FIG. 4, an alerting message is formatted into SMS message 411. However, embodiments support other formats including MMS and e-mail. In step 413, the SMS message is sent through a service provider in order to deliver SMS alert message 415 to the authorized person's communication terminal. The client's communication terminal can be one of various types, including a wireless phone, personal computer, personal digital assistant (PDA), cable telephone, and landline telephone. In step 417, the client's communication terminal acknowledges delivery of SMS alert message 415.

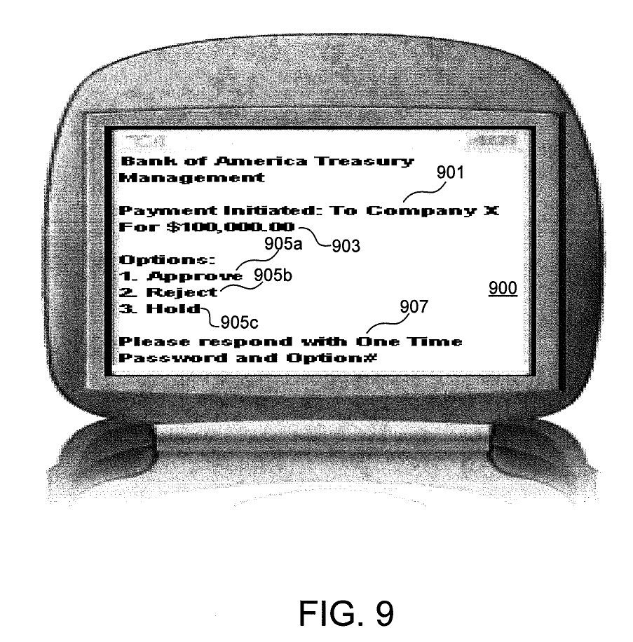

SMS alert message is displayed to the authorized person in step 419. FIG. 9 shows an exemplary display that enables the payment amount to be approved and options that can be selected by the authorized person. Actionable alerts may be generated to a communication device in SMS format with options for the clients to select from and respond with a one-time password (OTP) from a password generator device (token).

Client 455 responds by executing exclusive or (XOR) rule 421. Consequently, client (authorized person) 455 chooses either step 423 or step 425. With step 423, authorized person 455 chooses not to take any action on SMS alert 419 (i.e., the payment is neither approved nor denied). With step 425, a one-time password is generated so that a payment decision can be conveyed.

A purpose of a one-time password (OTP) is to make it more difficult to gain unauthorized access to restricted resources, like a computer account. Traditionally static passwords can more easily be accessed by an unauthorized intruder given enough attempts and time. By constantly altering the password, as is done with a one-time password, the risk can be greatly reduced. There are at least three types of one-time passwords: the first type uses a mathematical algorithm to generate a new password based on the previous, a second type that is based on time-synchronization between the authentication server and the client providing the password, and a third type that uses a mathematical algorithm, where the new password is based on a challenge (e.g., a random number chosen by the authentication server or transaction details) and a counter.

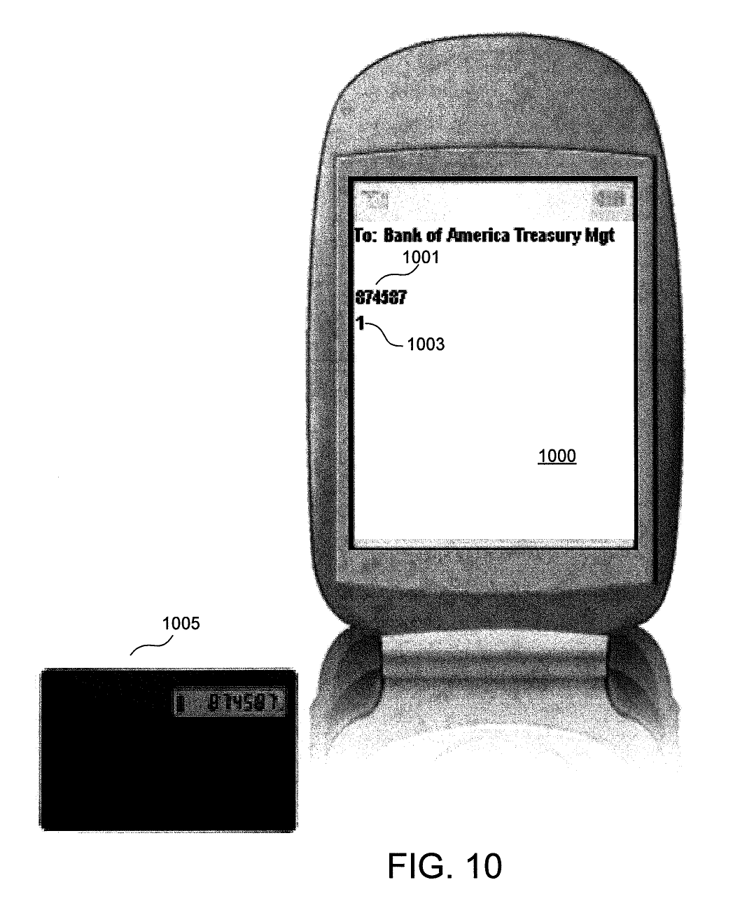

With an aspect, a time-synchronized one-time password is generated by a physical hardware token (password generator), where each client is given a personal token. Exemplary password generator 1005 is shown in FIG. 10. Inside the token is an accurate clock that has been synchronized with the clock on an authentication server (not shown). On an OTP system, time is an important part of the password algorithm since the generation of a new password is based on the current time rather than the previous password or a secret key. One-time password token may also be of the type that requires a password for the device in order to generate code which provides additional security.

Once the one-time password is generated, authorized person 455 includes the one-time password with an indication of approval or rejection in step 427. An illustrative screenshot of the authorized person's input is shown in FIG. 10.

FIG. 5 shows flow diagram 500 for client 455 responding to alerting message 419 and for a financial institution processing the client's response. Client 455 receives message 419 and determines what action to take on the alert. With an embodiment, client 455 uses a bank-provided one-time password generator to create a password for the response message. Client 455 may use a mobile device to respond to the alert message by including a determined one-time password and action selection from the multiple choice options and to send a SMS response to the channel mobile channel service.

In accordance with process 400, client 455 receives SMS alert message 419 and responds in step 501 by sending SMS response message 505 with one-time password and decision 503 regarding the deposition of the pending payment. As an example, response message 505 may be formatted as a concatenation of the one-time password and a numerical sequence that is indicative of a decision by the client. In steps 507 and 509, process 500 matches the response with the original alert message, verifies the one-time password, ensures that the response is not a duplicate, and subsequently initiates the action selected by client 455. With an embodiment, process 500 determines whether the received one-time password is valid based on time-synchronization between an authentication server and the client's password generator (token e.g., generator 1005 as shown in FIG. 10) providing the password,

The combination of business rules, actionable alerts that can trigger other business processes, mobile messaging, and secure one time password enables business process 500 to enhance treasury management capabilities. Step 509 provides log 511 of all successful or failed responses for subsequent security and auditing measures.

XOR rule 513 executes step 517 if the received password is invalid (step 515) and executes step 521 if the received password is valid (step 519). Process 500 receives response 505 from client 455 and determines if the response has been previously attempted. If this is a duplicate response after more than 3 failed attempts, process 500 ignores the response and future responses with the message identification. Otherwise, the process 500 verifies the password in the received message. If the password is validated (step 519), process 500 takes the action as specified by the client selected option and initiates the requested action within banking system 451.

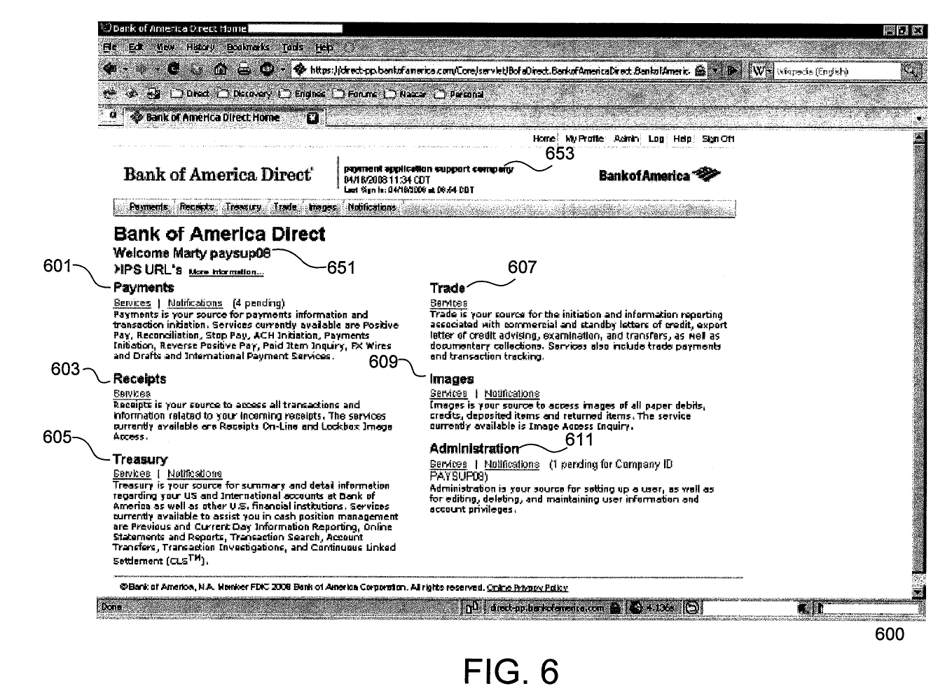

FIG. 6 shows webpage 600 for a payment service in accordance with an embodiment. A user (hypothetical “Marty paysup08” 651) of hypothetical company (client) “payment application support company” 653 logs into webpage 600 and may select one of several supported service selections, e.g., payments 601, receipts 603, treasury 605, trade 607, images 609, or administration 611. In the example shown in FIG. 6, the user may be a staff member of the business. The user may be a payment supervisor who initiates a pending payment and may approve the payment if the amount is less than a predetermined amount. However, if the amount exceeds the predetermined amount, a person with higher authority (e.g., corporate treasurer, corporate cash manager, or purchasing director) must approve the payment.

If the user selects payments 601, the user navigates to webpage 800 as shown in FIG. 8 so that a pending payment can be dispensed. If the user selects administration 611, the user navigates to webpage 700 as shown in FIG. 7 so that a user mobile profile can be created or updated or so that alert rules can be defined.

FIG. 7 shows webpage 700 for a client configuring a payment service in accordance with an embodiment. In order to access webpage 700, a client (user) selects administration selection 611 (as shown in FIG. 6) to sign up for corporate mobile banking service 351. (The person accessing webpage 700 may be different from the authorized person but has permission to configure the service.) By selecting “create user mobile profile” 701, the user can configure the communication device type, device ID, telecom carrier, and types of alerts (e.g., SMS, MMS, or e-mail) of an authorized person who can approve a pending payment as specified by define alert rules 705. In addition, scheduling rules may be specified for sending an alert. For example, an alerting message is sent to the authorized person between hours as specified by “send alerts during these hours” 703. In the example shown in screenshot 700, the authorized person is alerted in accordance with alert rules 705, where the pending payment is greater than $10,000 (rule 705a), the payee corresponds to the company as specified by “Company Name” (rule 705b), and the account name corresponds to the name specified as “Sample Account” and the account balance is less than $1,000 (rule 705c). Rules may be joined through AND, OR, NOT AND, or OR logic operations and may be grouped using parenthesis and evaluated in an hierarchical order similar to mathematical expressions and computational logic. With an embodiment, different authorized persons may be designated for different payees. For example, person A may be designated to approve pending payments to Company ABC and person B may be designated to approve pending payments to Company XYZ.

FIG. 8 shows screenshot 800 in which a client initiates a payment in accordance with an embodiment. With the embodiment, the person initiating the payment is typically different from the person authorized to approve the payment. The payee is associated with beneficiary bank information 801 and beneficiary information 803. When the user has completed entering information into the fields of screenshot 800, the user selects “save for approval” 805. After the desktop user has saved the payment for approval, the corporate mobile channel technology 351 evaluates the user defined rules in the background. If any of the alert rules evaluate to TRUE, then corporate mobile channel technology 351 triggers an alert and sends an SMS message to the authorized person to take action on the alert:

FIG. 9 shows exemplary display 900 on a wireless device in which a client (authorized person) receives an alerting message in accordance with an embodiment. Field 901 designates the payee (corresponding to rule 705b) for a payment amount of $100,000 as shown in field 903. Three options are provided in the alert: approve selection 905a corresponding to numerical value 1, reject selection 905b corresponding to numerical value 2, and hold selection 905c corresponding to numerical selection 3. Hold selection 905c denotes that the authorizing person has not explicitly decided on the disposition of the pending payment. The authorizing person may implicitly hold the pending payment by not responding to the alerting message. In field 907, the authorizing person is asked to respond with a one-time password and the selected option.

FIG. 10 shows exemplary response 1000 of an authorizing person to an alerting message in accordance with an embodiment. The authorizing person obtains the one-time password (“874587”) from credit card sized hardware token 1005. The authorizing person enters the numerical string “874587” into field 1001 and the option selection in field 1003. In the example shown in FIG. 10, the authorizing user enters “1” corresponding to the authorizing person approving the payment to Company X. The information shown on screenshot 1000 is sent a SMS response message to the client's financial institution (e.g., hypothetical Bank XYZ).

In accordance with process 500 (as shown in FIG. 5), corporate mobile channel technology 351 receives the SMS response message, processes the SMS response to ensure that it was received from the same device that the message was originally sent to, and parses the message for the password and option number. Process 500 subsequently validates the password to ensure that it matches the expected password from the user's token card and then directs the bank end bank system to take the action as directed by the user if the password is validated.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

We claim:

1. A computer-assisted method comprising:
(a) determining whether to send an alerting message to a designated user based on a criterion, wherein the alerting message is associated with a pending decision;
(b) in response to (a), sending the alerting message to a communication device of the designated user;
(c) receiving an alerting response from the communication device, the alerting response containing a decision choice and a password; and
(d) when the password is valid, initiating action in accordance with the decision choice.

2. The method of claim 1, wherein the password comprises a one time password and is generated from a password generator device.

3. The method of claim 1, wherein (b) comprises:
sending the alerting message using a short message service (SMS).

4. The method of claim 1, wherein (b) comprises:
sending the alerting message using a multimedia messaging service (MMS).

5. The method of claim 1, wherein (a) comprises:
(a)(i) determining whether a trigger condition has occurred; and
(a)(ii) generating the alerting message when the trigger condition has occurred.

6. The method of claim 5, wherein (a) further comprises:
(a)(iii) comparing decision parameters of the pending decision with a set of business rules to determine whether the trigger condition has occurred.

7. The method of claim 1, wherein the pending decision is associated with a pending payment.

8. The method of claim 7, wherein (d) comprises:
(d)(i) when the decision information indicates an approval, dispensing a payment to a payee.

9. The method of claim 7, wherein (d) comprises:
(d)(i) when the decision information indicates a rejection, rejecting the pending payment to a payee.

10. The method of claim 7, wherein (d) comprises:
(d)(i) when the decision information indicates a hold, placing the pending payment on hold.

11. The method of claim 6, wherein (a) further comprises:
(a)(iv) configuring the set of business rules from a user input.

12. The method of claim 1, wherein (b) comprises:
(b)(i) obtaining contact information from a profile for the designated user; and
(b)(ii) sending the alerting message to the designated user based on the contact information.

13. The method of claim 12, further comprising:
(e) configuring the profile from a user input.

14. The method of claim 1, further comprising:
(e) when a first trigger condition occurs, sending the alerting message to a first designated user; and
(f) when a second trigger condition occurs, sending the alerting message to a second designated user.

15. A computer-readable storage medium storing computer-executable instructions that, when executed, cause a processor to perform a method comprising:
(a) determining whether to send an alerting message to a designated user based on a criterion, wherein the alerting message is associated with a pending payment;
(b) in response to (a), sending the alerting message to a communication device of the designated user;
(c) receiving an alerting response from the communication device, the alerting response containing a payment choice and a one-time password; and
(d) when the one-time password is valid, initiating action in accordance with the payment choice.

16. The computer-readable medium of claim 15, said method further comprising:
(a)(i) determining whether a trigger condition has occurred; and
(a)(ii) generating the alerting message when the trigger condition has occurred.

17. The computer-readable medium of claim 16, said method further comprising:
(a)(iii) comparing payment parameters of the pending payment with a set of business rules to determine whether the trigger condition has occurred.

18. The computer-readable medium of claim 15, said method further comprising:
(d)(i) when the payment information indicates an approval, dispensing a payment to a payee.

19. The computer-readable medium of claim 15, said method further comprising:
(d)(i) when the payment information indicates a rejection, rejecting the pending payment to the payee.

20. The computer-readable medium of claim 15, said method further comprising:
(d)(i) when the payment information indicates a hold, placing the pending payment on hold.

21. An apparatus comprising:
a memory; and
a processor coupled to the memory and configured to perform, based on instructions stored in the memory:
(a) determining whether to send an alerting message to a designated user based on a criterion, wherein the alerting message is associated with a pending payment;
(b) in response to (a), sending the alerting message to a communication device of the designated user;
(c) receiving an alerting response from the communication device, the alerting response containing a payment choice and a one-time password; and
(d) when the one-time password is valid, initiating action in accordance with the payment choice.

22. The apparatus of claim 21, wherein the processor is further configured to perform:
(a)(i) determining whether a trigger condition has occurred; and
(a)(ii) generating the alerting message when the trigger condition has occurred; and
(a)(iii) comparing payment parameters of the pending payment with a set of business rules to determine whether the trigger condition has occurred.

23. The apparatus of claim 21, wherein the processor is further configured to perform:
(d)(i) when the payment information indicates an approval, dispensing a payment to a payee;
(d)(ii) when the payment information indicates a rejection, rejecting the pending payment to the payee; and
(d)(iii) when the payment information indicates a hold, placing the pending payment on hold.

24. A computer-assisted method comprising:
(a) comparing payment parameters of a pending payment with a set of business rules to determine whether a trigger condition has occurred.
(b) when the trigger condition has occurred, determining a designated user for reviewing the pending payment;
(c) sending a alerting message to a wireless device of the designated user via a short message service (SMS) in accordance with contact information;
(d) receiving an alerting response from the wireless device, the alerting response containing payment information and a one-time password;
(e) when the one-time password is valid and the payment information indicates an approval, dispensing a payment to a payee;
(f) when the one-time password is valid and the payment information indicates a rejection, rejecting the pending payment to the payee; and
(g) when the one-time password is valid and the payment information indicates a hold, placing the pending payment on hold.
